(19) United States
(12) Patent Application Publication
(10) Pub. No.: US 2008/0071517 A1
(43) Pub. Date: Mar. 20, 2008

(54) Emulations system and emulation method

(75) Inventor: Hiroyuki Kubo, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/901,680

(22) Filed: Sep. 18, 2007

(30) Foreign Application Priority Data
Sep. 19, 2006 (JP) 2006-252787

(51) Int. Cl. G06F 9/455

(52) U.S. Cl. 703/23

(57) ABSTRACT

An emulation system emulates an operation of a target device including a first analog signal processing section and includes: an emulation device and a semiconductor device having a second analog signal processing section and an external terminal to which at least one of an input and an output of the second analog signal processing section is connected. The second analog signal processing section has analog characteristics similar to analog characteristics of the first analog signal processing section. The emulation device is connected to the external terminal.

Japanese Patent Application No. 2006-252787, filed on Sep. 19, 2006, is hereby incorporated by reference in its entirety.

### BACKGROUND OF THE INVENTION

The present invention relates to an emulation system and an emulation method.

A method is known in which the operation of a peripheral circuit provided in a real device is terminated and a peripheral circuit provided in another external device (alternative device) is connected to the real device to emulate the operation of the target device. According to this emulation method, the target program can be efficiently debugged when developing various devices using a general-purpose CPU while changing a peripheral digital circuit depending on the application. Japanese Patent No. 3452147 discloses technology in this field, for example.

However, when the alternative device includes an analog circuit, emulation taking analog characteristics into account cannot be performed since the alternative device and the target device differ in analog characteristics. Therefore, it is difficult to find a bug in the target program due to the difference in analog characteristics between the target device and the alternative device.

Even if a bug in the target program due to analog characteristics is found after completing the prototype of the target device, it is difficult to debug the target program when an on-chip debugging function (e.g. breakpoint setting and step execution) is not incorporated in the target device. On the other hand, the scale of the target device increases when incorporating the on-chip debug function in the target device, whereby cost increases.

### SUMMARY

According to a first aspect of the invention, there is provided an emulation system which emulates an operation of a target device including a first analog signal processing section, the emulation system comprising:

a semiconductor device including a second analog signal processing section and an external terminal to which at least one of an input and an output of the second analog signal processing section is connected; and

an emulation device;

the second analog signal processing section having analog characteristics which is similar to analog characteristics of the first analog signal processing section; and

the emulation device being connected to the external terminal.

According to a second aspect of the invention, there is provided a method of emulating an operation of a target device including a first analog signal processing section, the method comprising:

causing a semiconductor device, which includes a second analog signal processing section and an external terminal through which a signal from the second analog signal processing section is output to the outside, to supply a signal from the second analog signal processing section to an emulation device through the external terminal, the second analog signal processing section having analog characteristics similar to analog characteristics of the first analog signal processing section; and

causing the emulation device to perform a process based on the signal supplied by the semiconductor device.

According to a third aspect of the invention, there is provided a method of emulating an operation of a target device including a first analog signal processing section, the method comprising:

causing an emulation device to generate a signal to be input to a second analog signal processing section of a semiconductor device and to supply the generated signal to an external terminal of the semiconductor device, the second analog signal processing section having analog characteristics similar to analog characteristics of the first analog signal processing section, and a signal from the outside being input to the second analog signal processing section through the external terminal; and

causing the second analog signal processing section to perform a process based on the supplied signal.

### BRIEF DESCRIPTION OF THE SEVERAL VIEWS OF THE DRAWING

FIG. 1 is a diagram showing a utilization state of an emulation system according to one embodiment of the invention.

FIG. 2 is a diagram for illustrating the configuration of an emulation system according to one embodiment of the invention.

FIG. 3 is a block diagram of a semiconductor device (real device) according to one embodiment of the invention.

### DETAILED DESCRIPTION OF THE EMBODIMENT

The invention may provide an emulation system which can emulate the operation of a target device taking analog characteristics into account without incorporating an on-chip debugging function in the target device.

(1) According to one embodiment of the invention, there is provided an emulation system which emulates an operation of a target device including a first analog signal processing section, the emulation system comprising:

a semiconductor device including a second analog signal processing section and an external terminal to which at least one of an input and an output of the second analog signal processing section is connected; and

an emulation device;

the second analog signal processing section having analog characteristics which is similar to analog characteristics of the first analog signal processing section; and

the emulation device being connected to the external terminal.

According to this embodiment, since the emulation device operates in a state in which the emulation device is connected with the analog signal processing section having characteristics similar to the characteristics of the analog signal processing section provided in the target device, an emulation system taking into account the characteristics of the analog signal processing section of the target device can be provided. Specifically, the input signal can be supplied from the emulation device to the analog signal processing section of the semiconductor device through the external terminal of the semiconductor device, or the emulation device can perform a process based on the output signal of the analog signal processing section of the semiconductor device.

This makes it possible to find a bug in the target program due to the characteristics of the analog signal processing section. Moreover, since the emulation device has various debugging functions such as breakpoint setting and step execution, even if a bug caused by the characteristics of the analog signal processing section exists in the target program, the target program can be relatively easily debugged. This increases debugging efficiency without incorporating an on-chip debugging function in the target device.

The semiconductor device includes an analog signal processing section having characteristics similar to the characteristics of the analog signal processing section of the target device. For example, the semiconductor device may be an existing semiconductor device which includes an analog signal processing section having the same characteristics as the characteristics of the analog signal processing section of the target device, or may be a target device in which the target program is not provided.

The analog signal processing section includes a portion which processes an analog signal. The analog signal processing section may process only an analog signal, or may include a portion which processes a digital signal. Examples of the analog signal processing section include a liquid crystal display (LCD) driver, an analog/digital converter (AD converter), a digital/analog converter (DA converter), and the like.

Only the input or the output of the analog signal processing section may be connected to the emulation device through the external terminal, or the input and the output of the analog signal processing section may be connected to the emulation device through the external terminal. When connecting the input of the analog signal processing section to the emulation device, all or some of the inputs of the analog signal processing section may be respectively connected to the emulation device through different external terminals. When connecting the output of the analog signal processing section to the emulation device, all or some of the outputs of the analog signal processing section may be respectively connected to the emulation device through different external terminals.

The external terminal to which at least one of the input and the output of the analog signal processing section can be connected may be a dedicated external terminal to which at least one of the input and the output of the analog signal processing section is always connected, or an external terminal to which a signal other than the input or the output of the analog signal processing section is connected during normal operation and to which at least one of the input and the output of the analog signal processing section is connected only when the emulation mode is selected by a predetermined mode setting.

(2) In this emulation system, a signal may be output to the outside from the second analog signal processing section through the external terminal; and the emulation device may perform a process based on the signal output through the external terminal.

According to this embodiment, since the semiconductor device can supply the output signal of the analog signal processing section to the emulation device through the external terminal, the emulation device can perform a process based on the output signal of the analog signal processing section. Since the operation of the target device can be emulated taking into account the characteristics of the analog signal processing section, it is possible to find a bug in the target program caused by the characteristics of the analog signal processing section.

For example, when the analog signal processing section is an AD converter, the CPU can perform a process based on a multi-bit digital signal output from the AD converter. Therefore, the operation of the target device can be emulated taking into account the characteristics of the AD converter. This makes it possible to find a bug in the target program caused by the characteristics of the AD converter.

(3) In this emulation system, a signal may be input from the outside to the second analog signal processing section through the external terminal; and the emulation device may generate a signal to be input to the second analog signal processing section and supply the generated signal to the external terminal.

According to this embodiment, since the emulation device can generate the input signal of the analog signal processing section of the semiconductor device and supply the generated signal through the external terminal, the emulation device can emulate the operation of the target device taking into account the characteristics of the analog signal processing section. This makes it possible to find a bug in the target program due to the characteristics of the analog signal processing section.

For example, when the analog signal processing section is an LCD driver, the operation of the target device can be emulated taking into account the characteristics of the LCD driver by supplying a predetermined control signal to the LCD driver from the emulation device. Therefore, the operation of the target device can be checked before production by monitoring the display state of an LCD panel connected to the output of the LCD driver. This makes it possible to find a bug in the target program caused by the characteristics of the LCD driver.

(4) In this emulation system, the semiconductor device may include a mode setting terminal and select whether or not to connect at least one of the input and the output of the second analog signal processing section to the external terminal based on a state of the mode setting terminal.

According to this embodiment, even if the input or the output of the analog signal processing section is not connected to the external terminal of the semiconductor device during normal operation, the input or the output of the analog signal processing section is connected to the external terminal by setting the mode setting terminal in a predetermined state. Specifically, since an emulation system can be provided in which the emulation device and the analog signal processing section of the semiconductor device are connected through the external terminal, the emulation device can emulate the operation of the target device taking into account the characteristics of the analog signal processing section. This makes it possible to find a bug in the target program due to the characteristics of the analog signal processing section.

For example, there may be a case where the output of the analog signal processing section cannot be connected to the external terminal in the normal operation mode since the number of external terminals of the semiconductor device is small, or the output of the analog signal processing section is not connected to the external terminal in the normal operation mode in order to prevent deterioration in characteristics of the semiconductor device. In such a case, the output of the analog signal processing section can be connected to the external terminal in the emulation mode by setting the mode setting terminal in a predetermined state. Therefore, the operation of the target device can be emulated in a state in which the emulation device is connected to the analog signal processing section. When selecting the emulation mode, the operation of part or the entirety of the signal processing of the semiconductor device other than the analog signal processing section may or may not be terminated.

The number of mode setting terminals may be one or more. For example, when the semiconductor device includes two or more analog signal processing sections, the emulation system may be configured so that it is possible to select whether to connect the input/output of each analog signal processing section to the external terminal or to connect the input of one analog signal processing section and the output of another analog signal processing section to the external terminal by combining the inputs of the mode setting terminals.

(5) In this emulation system, the emulation device may include a digital signal processing section; and part or the entirety of the digital signal processing section may be implemented by a semiconductor device including programmable logic elements.

According to this embodiment, since the emulation device also includes the digital signal processing section, an emulation system can be provided in which not only the analog signal processing section but also the digital signal processing section is connected. For example, when the target device communicates with an external device by controlling an external interface circuit, the control program of the external interface circuit can be efficiently debugged by incorporating the external interface circuit in the emulation device. When newly designing an interface circuit for the digital signal processing section and the analog signal processing section, a logic circuit equivalent to the interface circuit may be implemented by a semiconductor device including programmable logic elements and incorporated in the emulation device. Therefore, emulation taking analog characteristics into account can be performed by connecting the emulation device and a semiconductor device having analog characteristics similar to the analog characteristics of the analog signal processing section included in the target device.

According to this embodiment, when the design of the digital signal processing section of the target device has been completed, the function of the digital signal processing section can be implemented by the semiconductor device including programmable logic elements before the prototype of the target device is completed. Therefore, the operation of the target device can be emulated using the control program of the digital signal processing section. This makes it possible to debug the control program of the digital signal processing section in an early stage.

The entire digital signal processing section may be implemented by the semiconductor device including programmable logic elements, or only part of the digital signal processing section may be implemented by the semiconductor device including programmable logic elements. For example, when the CPU included in the target device is not a general-purpose CPU, the emulation device may be formed by implementing the entire digital processing section including the CPU using a semiconductor device including programmable logic elements. When the CPU included in the target device is a general-purpose CPU, the emulation device may be formed by implementing the digital processing section other than the CPU using a semiconductor device including programmable logic elements.

The semiconductor device including programmable logic elements is not limited insofar as an arbitrary logic circuit can be formed by external control. The semiconductor device including programmable logic elements may be a field programmable gate array (FPGA) or a complex programmable logic device (CPLD).

(6) According to one embodiment of the invention, there is provided a method of emulating an operation of a target device including a first analog signal processing section, the method comprising:

causing a semiconductor device, which includes a second analog signal processing section and an external terminal through which a signal from the second analog signal processing section is output to the outside, to supply a signal from the second analog signal processing section to an emulation device through the external terminal, the second analog signal processing section having analog characteristics similar to analog characteristics of the first analog signal processing section; and

causing the emulation device to perform a process based on the signal supplied by the semiconductor device.

According to this embodiment, since the semiconductor device can supply the output signal of the analog signal processing section to the emulation device through the external terminal, the emulation device can perform a process based on the output signal of the analog signal processing section. Since the operation of the target device can be emulated taking into account the characteristics of the analog signal processing section, it is possible to find a bug in the target program caused by the characteristics of the analog signal processing section.

Even if the output of the analog signal processing section of the semiconductor device is not connected to the external terminal during the normal operation, the output of the analog signal processing section may be connected to the external terminal by setting the mode setting terminal in a predetermined state. For example, there may be a case where the output of the analog signal processing section cannot be connected to the external terminal in the normal operation mode since the number of external terminals of the semiconductor device is small, or the output of the analog signal processing section is not connected to the external terminal in the normal operation mode in order to prevent deterioration in characteristics of the semiconductor device. In such a case, the output of the analog signal processing section may be connected to the external terminal in the emulation mode by setting the mode setting terminal in a predetermined state. When selecting the emulation mode, the operation of part or the entirety of the signal processing of the semiconductor device other than the analog signal processing section may or may not be terminated.

The number of mode setting terminals may be one or more. For example, when the semiconductor device includes two or more analog signal processing sections, the output of each analog signal processing section may be connected to the external terminal by combining the inputs of the mode setting terminals.

When the target device includes a digital signal processing section, an emulation method can also be provided in which the emulation device is connected to the analog signal processing section and a digital signal processing section by incorporating a digital signal processing section having the same logic as that of the digital signal processing section of the target device in the emulation device. For example, when the target device communicates with an external device by controlling an external interface circuit, the control program of the external interface circuit can be efficiently debugged by incorporating the external interface circuit in the emulation device. When newly designing an interface circuit for the digital signal processing section and the analog signal processing section, a logic circuit equivalent to the interface circuit may be implemented by a semiconductor device including programmable logic elements and incorporated in the emulation device. Therefore, emulation taking analog characteristics into account can be performed by connecting a semiconductor device having analog characteristics similar to the analog characteristics of the analog signal processing section of the target device with the emulation device.

When the design of the digital signal processing section of the target device has been completed, the function of the digital signal processing section can be implemented by the semiconductor device including programmable logic elements before the prototype of the target device is completed. Therefore, the operation of the target device can be emulated using the control program of the digital signal processing section. This makes it possible to debug the control program in an early stage.

(7) According to one embodiment of the invention, there is provided a method of emulating an operation of a target device including a first analog signal processing section, the method comprising:

causing an emulation device to generate a signal to be input to a second analog signal processing section of a semiconductor device and to supply the generated signal to an external terminal of the semiconductor device, the second analog signal processing section having analog characteristics similar to analog characteristics of the first analog signal processing section, and a signal from the outside being input to the second analog signal processing section through the external terminal; and

causing the second analog signal processing section to perform a process based on the supplied signal.

According to this embodiment, since the emulation device can generate the signal input to the analog signal processing section of the semiconductor device and supply the generated signal through the external terminal, the analog signal processing section of the semiconductor device can perform a process based on the input signal. Since the operation of the target device can be emulated taking into account the characteristics of the analog signal processing section, it is possible to find a bug in the target program caused by the characteristics of the analog signal processing section.

Even if the input of the analog signal processing section of the semiconductor device is not connected to the external terminal during the normal operation, the input of the analog signal processing section may be connected to the external terminal by setting the mode setting terminal in a predetermined state. For example, there may be a case where the input of the analog signal processing section cannot be connected to the external terminal in the normal operation mode since the number of external terminals of the semiconductor device is small, or the input of the analog signal processing section is not connected to the external terminal in the normal operation mode in order to prevent deterioration in characteristics of the semiconductor device. In such a case, the input of the analog signal processing section may be connected to the external terminal in the emulation mode by setting the mode setting terminal in a predetermined state. When selecting the emulation mode, the operation of part or the entirety of the signal processing of the semiconductor device other than the analog signal processing section may or may not be terminated.

The number of mode setting terminals may be one or more. For example, when the semiconductor device includes two or more analog signal processing sections, the input of each analog signal processing section may be connected to the external terminal by combining the inputs of the mode setting terminals.

When the target device includes a digital signal processing section, an emulation method can also be provided in which the emulation device is connected to the analog signal processing section and a digital signal processing section by incorporating a digital signal processing section having the same logic as that of the digital signal processing section of the target device in the emulation device. For example, when the target device communicates with an external device by controlling an external interface circuit, the control program of the external interface circuit can be efficiently debugged by incorporating the external interface circuit in the emulation device. When newly designing an interface circuit for the digital signal processing section and the analog signal processing section, a logic circuit equivalent to the interface circuit may be implemented by a semiconductor device including programmable logic elements and incorporated in the emulation device. Therefore, emulation taking analog characteristics into account can be performed by connecting a semiconductor device having analog characteristics similar to the analog characteristics of the analog signal processing section of the target device with the emulation device.

When the design of the digital signal processing section of the target device has been completed, the function of the digital signal processing section can be implemented by the semiconductor device including programmable logic elements before the prototype of the target device is completed. Therefore, the operation of the target device can be emulated using the control program of the digital signal processing section. This makes it possible to debug the control program in an early stage.

The embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

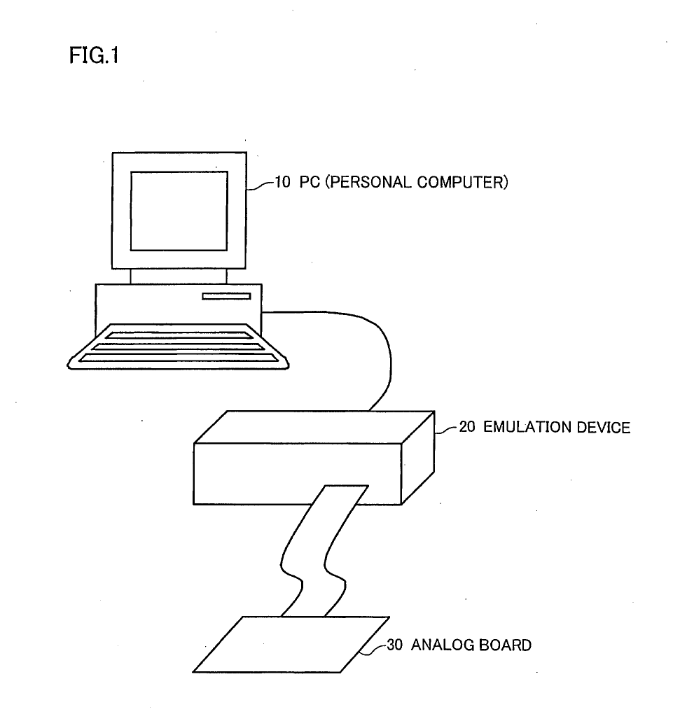

FIG. 1 is a diagram showing a utilization state of an emulation system according to this embodiment.

The emulation system according to this embodiment includes a personal computer (PC) 10, an emulation device 20, and an analog board 30. The emulation device 20 includes a CPU, a peripheral digital block, a memory, and the like. A semiconductor device including an analog signal processing section and the like are provided on the analog board 30. The PC 10 and the emulation device 20 are connected through a cable, and perform data communication through a Universal Serial Bus (USB) interface or the like.

A target program is loaded from the PC 10 into the memory included in the emulation device 20 before performing emulation. The emulation device and the analog board are connected through a cable. The CPU, the peripheral digital block, the memory storing the target program, the analog signal processing section, and the like make up an emulation system taking into account the characteristics of an analog signal processing section of a target device.

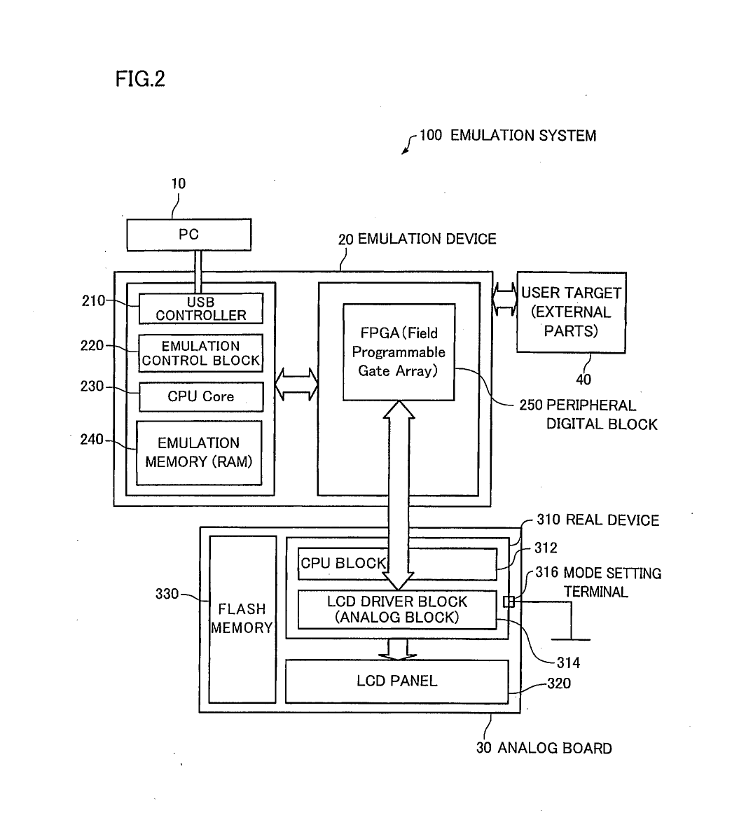

FIG. 2 is a diagram for illustrating the configuration of the emulation system according to this embodiment.

An emulation system 100 includes the personal computer (PC) 10, the emulation device 20, and the analog board 30 provided with a real device 310 (example of semiconductor device including analog signal processing section).

The PC 10 and the emulation device 20 are connected through a USB cable. The PC 10 and the emulation device 20 perform data communication necessary for emulation under control of a USB controller 210. The PC 10 and the emulation device 20 need not necessarily perform data communication through the USB interface. Another interface may also be used.

The emulation device 20 includes an emulation memory 240, a CPU 230, a peripheral digital block 250, the USB controller 210, and an emulation control block 220.

The CPU 230 and the peripheral digital block 250 make up a digital signal processing section. The peripheral digital block 250 includes an external digital interface circuit, a timer, various control registers, and the like. The peripheral digital block 250 is implemented by an FPGA which is a semiconductor device including programmable logic elements. The CPU 230 is generally implemented by a general-purpose CPU device, but may be implemented by an FPGA.

The emulation memory 240 is a rewritable memory. The emulation memory 240 may be a volatile random access memory (RAM) or a nonvolatile memory such as a flash memory or an electrically erasable programmable read only memory (EEPROM). A target program as a debugging target is stored in the emulation memory 240. The target program may be transmitted from the PC 10 to the emulation device 20 and stored in the emulation memory 240 before performing emulation, or a memory storing the target program may be provided in the emulation device.

The CPU 230 may be the same type of CPU as the CPU provided in the target device, or may be another CPU which operates in the same manner as the CPU provided in the target device. The CPU 230 executes each instruction of the target program stored in the emulation memory 240. For example, the CPU 230 executes an instruction for writing a predetermined setting value in the control register (not shown) included in the peripheral digital block 250. This enables a user target 40 connected to the emulation device 20 to be controlled. The user target 40 includes external parts such as a switch and a buzzer.

The CPU 230 may control an LCD driver block (analog block) 314 through the peripheral digital block 250 by executing an instruction for writing a predetermined setting value in the control register included in the peripheral digital block 250, or may output a signal for controlling the LCD driver block 314.

The emulation control block 220 performs control necessary for implementing a debugging function such as terminating execution of the instruction stored in the emulation memory 240 each time the instruction is executed by one step (step execution) or terminating execution of the instruction at a breakpoint set by the PC 10.

The analog board 30 includes a real device 310, an LCD panel 320, and a flash memory 330.

The real device 310 includes an LCD driver block 314 (example of analog block or analog signal processing section), a mode setting terminal 316, an external terminal (not shown) to which at least one of the input and the output of the analog signal processing section can be connected, a CPU block 312, a peripheral digital block (not shown), a built-in ROM (not shown), and the like. The LCD driver block 314 outputs a signal for controlling display of the LCD panel 320.

The real device 310 is a semiconductor device configured so that the characteristics of the LCD driver block (analog block) 314 is similar to the characteristics of the LCD driver block included in the target device. For example, the real device 310 may be the same type of semiconductor device as the target device except that the target program is not stored in the built-in ROM, or may be another type of existing semiconductor device which has been developed in advance. The target program may be written into the built-in ROM of the real device 310. Or, only part of the target program may be written into the built-in ROM of the real device 310, or the target program may not be written into the built-in ROM of the real device 310.

The real device 310 is set in a normal operation mode when the mode setting terminal 316 is set at the H level, and set in an emulation mode when the mode setting terminal 316 is set at the L level. Note that it suffices that the normal operation mode and the emulation mode be selected by setting the polarity of the mode setting terminal 316. Specifically, the real device 310 may be set in the normal operation mode when the mode setting terminal 316 is set at the L level, and set in the emulation mode when the mode setting terminal 316 is set at the H level. In the normal operation mode, a control signal is supplied to the LCD driver block (analog block) 314 from the CPU block 312 in the real device 310. In the emulation mode, a control signal is supplied to the LCD driver block (analog block) 314 from the emulation device 20 through a predetermined external terminal (not shown) of the real device 310. In the emulation system according to this embodiment, the mode setting terminal 316 is fixed at the L level so that the real device 310 is always set in the emulation mode. Therefore, the LCD driver block (analog block) 314 is controlled using the control signal supplied through a predetermined external input terminal.

Since the real device 310 is generally enclosed in a package provided with a minimum number of terminals in order to reduce cost and the mounting area, most external terminals of the package are used to input and output necessary signals to and from an external device during normal operation. Therefore, interface signals of the digital block and the analog block in the real device 310 are generally not connected to the external terminals in the normal operation mode. When the number of external terminals is small, the external terminal may be used so that the signal connected to the external terminal differs between the normal operation mode and the emulation mode. When the number of external terminals is large, an external terminal may be used to which an input/output signal of the analog block is exclusively connected. In this case, the mode setting terminal 316 is unnecessary.

When switching only the input of the LCD driver block (analog block) 314 by changing the polarity of the mode setting terminal 316, one mode setting terminal may be provided. When two or more analog blocks exist, two or more mode setting terminals may be provided to selectively connect the input or the output of each analog block to the external terminal.

In the emulation system according to this embodiment, since the LCD panel 320 is provided in the analog board 30 as an external device, the LCD driver block 314 is used as the analog signal processing section. The analog signal processing section according to this embodiment may be an analog/digital (AD) converter, a digital/analog (DA) converter, or the like depending on the type of peripheral device.

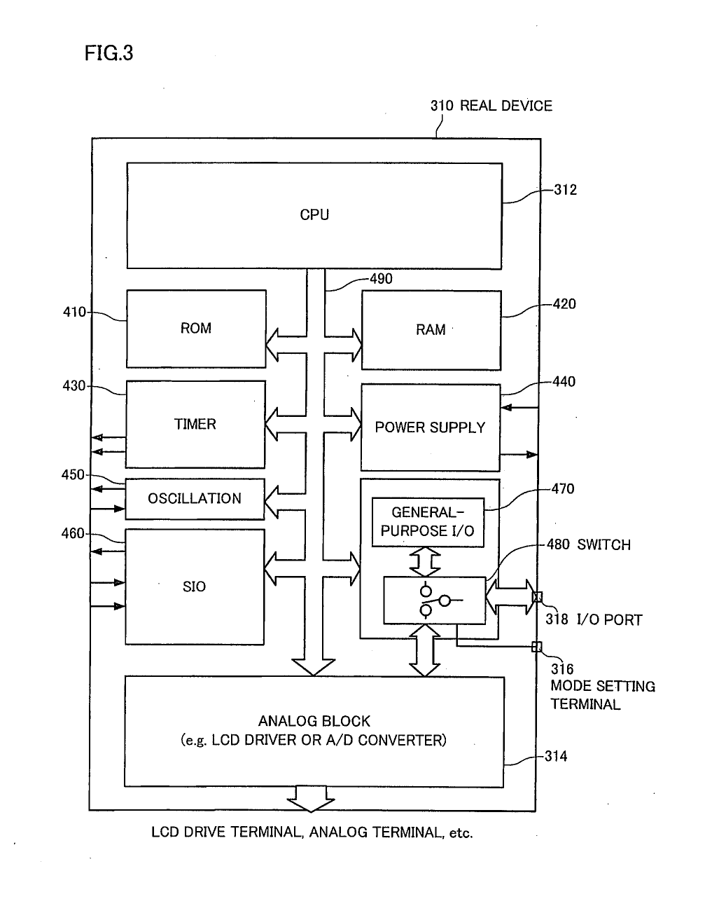

FIG. 3 shows an example of a block diagram of the semiconductor device (real device) included in the emulation system according to this embodiment.

The real device 310 includes the analog block (e.g. LCD driver or A/D converter; example of the analog signal processing section) 314, the mode setting terminal 316, an I/O port 318, the CPU 312, a read only memory (ROM) 410, a random access memory (RAM) 420, a timer 430, a power supply circuit 440, an oscillation circuit 450, a serial interface (I/O) (SIO) circuit 460, a general-purpose I/O circuit 470, a switch circuit 480, and an internal signal line 490 which interconnects these blocks.

The analog block 314 is an analog signal processing section having characteristics which is similar to the characteristics of the analog signal processing section of the target device.

The I/O port 318 functions as an external terminal to which at least one of the input and the output of the analog block 314 can be connected. At least one output signal of the analog block 314 may be output to the I/O port 318, or at least one input signal of the analog block 314 may be input through the I/O port 318. The input and the output of the analog block 314 may be respectively connected to different I/O ports 318.

The timer 430 and the SIO interface circuit 460 make up a digital signal processing section. In the emulation system according to this embodiment, a logic circuit equivalent to the timer 430 and the SIO interface circuit 460 is implemented by an FPGA as the peripheral digital block 250, for example.

The target program may be written into the ROM 410. Or, only part of the target program may be written into the ROM 410, or the target program may not be written into the ROM 410.

The mode setting terminal 316 is used to select whether to set the real device 310 in the normal operation mode or the emulation mode.

For example, the real device 310 may be set in the normal operation mode when the mode setting terminal 316 is set at the H level, and set in the emulation mode when the mode setting terminal 316 is set at the L level. Or, the real device 310 may be set in the normal operation mode when the mode setting terminal 316 is set at the L level, and set in the emulation mode when the mode setting terminal 316 is set at the H level.

When the normal operation mode has been selected, the switch circuit 480 operates so that the I/O port 318 is connected to the general-purpose I/O circuit 470. When the emulation mode has been selected, the switch circuit 480 operates so that the I/O port 318 is connected to the input or the output of the analog block 314. When the emulation mode has been selected, the input signal may be supplied to the analog block 314 from the emulation device 20 through the I/O port 318, or the output of the analog block 314 may be supplied to the emulation device 20 through the I/O port 318. Therefore, the emulation system according to this embodiment can provide an emulation environment taking into account the characteristics of the analog signal processing section of the target device.

The CPU 312 may execute each instruction of the program stored in the ROM 410 in the normal operation mode, and the operations of the CPU 310, the ROM 410, the RAM 420, the timer 430, the SIO interface circuit 460, and the general-purpose I/O circuit 470 may be terminated in the emulation mode. The operation of the oscillation circuit 450 may also be terminated when the analog block does not require a clock signal.

The real device 310 is a device in which the characteristics of the analog block 314 is similar to the characteristics of the analog signal processing section of the target device. The real device 310 may be the same type of semiconductor device as the target device excluding the ROM 410.

The emulation system according to this embodiment can provide an appropriate emulation environment depending on the development stage of the target device.

Since a semiconductor device of which the characteristics is similar to the characteristics of the analog signal processing section provided in the target device can be used as the real device 310, the target program can be completely debugged before completing the prototype of the target device. In this case, not only the development period of the target program but also cost accompanying correction of a mask used to produce the target device can be reduced.

When a semiconductor device of which the characteristics is similar to the characteristics of the analog signal processing section provided in the target device does not exist, an emulation environment taking into account the characteristics of the analog signal processing section provided in the target device cannot be provided unless the prototype of the target device is completed. Therefore, the target program cannot be completely debugged when different processes are performed in the target program depending on the characteristics of the analog signal processing section. However, the portion of the target program which is not affected by the characteristics of the analog signal processing section (i.e., calculation process in the CPU or portion for controlling only the digital peripheral block) can be debugged when the design of the CPU and the digital peripheral block provided in the target device has been completed.

When the same type of CPU is provided in different types of devices, a general-purpose CPU device may be provided as the CPU 230. Since the peripheral digital block 250 is designed in different ways depending on the product, it is not realistic to provide a general-purpose device as the peripheral digital block 250. Therefore, it is efficient to implement the peripheral digital block 250 using a semiconductor device (e.g. FPGA) including a programmable logic element. Therefore, the emulation device according to this embodiment has a configuration in which only the peripheral digital block 250 is implemented by the FPGA. When a general-purpose CPU device does not exist such as when newly designing a CPU, for example, the entire digital signal processing section including the CPU 230 and the peripheral digital block 250 may be implemented by an FPGA. This allows the target program to be initially debugged before the prototype of the target device is completed.

The analog signal processing section can be designed while initially debugging the target program. The prototype of the target device can be produced when the analog signal processing section and the like have been completely designed, even if initial debugging of the target program has not been completed.

In the emulation system according to this embodiment, the above prototype may be used as the real device 310. Since the target program has not been completely debugged, only the part of the program which has been debugged may be stored in the ROM of the prototype, or the program may not be stored in the ROM of the prototype. A program of which the process differs depending on the characteristics of the analog signal processing section of the target device can be debugged using the prototype as the real device 310.

When the target device includes a rewritable nonvolatile memory, the debugged target program may be written into the nonvolatile memory before shipment of mass-produced products. When the target program is small, the target program is generally provided in the target device as a mask ROM. In this case, mass production of the target device provided with the target program as the mask ROM can be started by changing only the mask of the wiring layer after debugging the target program.

Specifically, the emulation system according to this embodiment allows debugging of the target program to be started when the digital signal processing section has been completely designed, and can provide an emulation environment taking into account the characteristics of the analog signal processing section after the prototype of the target device has been completed. Even if the target device includes the analog signal processing section, the target program can be efficiently debugged using the debugging function provided to the emulation device 20. Therefore, the target program can be completed quickly, whereby cost accompanying a change in mask required for program debugging and the development man-hours of the target device can be reduced.

When the prototype of the target device has a function of executing a program stored in an external memory, the real device 310 may be set in the normal operation mode by setting the mode setting terminal at the H level, and the target program stored in the external flash memory 330 may be executed. Specifically, simple emulation can be executed or demonstrated using only the analog board after the prototype of the target device has been completed.

Moreover, the emulation system according to this embodiment ensures that a logic design error of the digital peripheral block or the like may be found before producing a mask of the prototype of the target device by implementing the digital peripheral block 250 using an FPGA during initial debugging of the target program. In this case, since the logical correction of the digital peripheral block can be reflected in the prototype, an increase in cost due to unnecessary mask correction can be prevented.

The invention is not limited to the above-described embodiments. Various modifications and variations may be made without departing from the scope of the invention.

For example, two or more emulation modes may be realized by providing two or more mode setting terminals 316 and combining two or more switch circuits so that one set is selected from the input/output signals of the analog block 314 and connected to the I/O port 318 by combining the settings of the mode setting terminals.

Although only some embodiments of this invention have been described above in detail, those skilled in the art will readily appreciate that many modifications are possible in the embodiments without materially departing from the novel teachings and advantages of the invention. Accordingly, all such modifications are intended to be included within the scope of the invention.

What is claimed is:

1. An emulation system which emulates an operation of a target device including a first analog signal processing section, the emulation system comprising:
a semiconductor device including a second analog signal processing section and an external terminal to which at least one of an input and an output of the second analog signal processing section is connected; and
an emulation device;
the second analog signal processing section having analog characteristics which is similar to analog characteristics of the first analog signal processing section; and
the emulation device being connected to the external terminal.

2. The emulation system as defined in claim 1,
wherein a signal is output to the outside from the second analog signal processing section through the external terminal; and
wherein the emulation device performs a process based on the signal output through the external terminal.

3. The emulation system as defined in claim 1,
wherein a signal is input from the outside to the second analog signal processing section through the external terminal; and
wherein the emulation device generates a signal to be input to the second analog signal processing section and supplies the generated signal to the external terminal.

4. The emulation system as defined in claim 2,
wherein a signal is input from the outside to the second analog signal processing section through the external terminal; and
wherein the emulation device generates a signal to be input to the second analog signal processing section and supplies the generated signal to the external terminal.

5. The emulation system as defined in claim 1,
wherein the semiconductor device includes a mode setting terminal and selects whether or not to connect at least one of the input and the output of the second analog signal processing section to the external terminal based on a state of the mode setting terminal.

6. The emulation system as defined in claim 2,
wherein the semiconductor device includes a mode setting terminal and selects whether or not to connect at least one of the input and the output of the second analog signal processing section to the external terminal based on a state of the mode setting terminal.

7. The emulation system as defined in claim 3,
wherein the semiconductor device includes a mode setting terminal and selects whether or not to connect at least one of the input and the output of the second analog signal processing section to the external terminal based on a state of the mode setting terminal.

8. The emulation system as defined in claim 4,
wherein the semiconductor device includes a mode setting terminal and selects whether or not to connect at least one of the input and the output of the second analog signal processing section to the external terminal based on a state of the mode setting terminal.

9. The emulation system as defined in claim 1,
wherein the emulation device includes a digital signal processing section; and
wherein part or the entirety of the digital signal processing section is implemented by a semiconductor device including programmable logic elements.

10. The emulation system as defined in claim 2,
wherein the emulation device includes a digital signal processing section; and
wherein part or the entirety of the digital signal processing section is implemented by a semiconductor device including programmable logic elements.

11. The emulation system as defined in claim 3,
wherein the emulation device includes a digital signal processing section; and
wherein part or the entirety of the digital signal processing section is implemented by a semiconductor device including programmable logic elements.

12. The emulation system as defined in claim 4,
wherein the emulation device includes a digital signal processing section; and
wherein part or the entirety of the digital signal processing section is implemented by a semiconductor device including programmable logic elements.

13. The emulation system as defined in claim 5,
wherein the emulation device includes a digital signal processing section; and
wherein part or the entirety of the digital signal processing section is implemented by a semiconductor device including programmable logic elements.

14. The emulation system as defined in claim 6,
wherein the emulation device includes a digital signal processing section; and
wherein part or the entirety of the digital signal processing section is implemented by a semiconductor device including programmable logic elements.

15. The emulation system as defined in claim 7,
wherein the emulation device includes a digital signal processing section; and
wherein part or the entirety of the digital signal processing section is implemented by a semiconductor device including programmable logic elements.

16. The emulation system as defined in claim 8,
wherein the emulation device includes a digital signal processing section; and
wherein part or the entirety of the digital signal processing section is implemented by a semiconductor device including programmable logic elements.

17. A method of emulating an operation of a target device including a first analog signal processing section, the method comprising:
causing a semiconductor device, which includes a second analog signal processing section and an external terminal through which a signal from the second analog signal processing section is output to the outside, to supply a signal from the second analog signal processing section to an emulation device through the external terminal, the second analog signal processing section having analog characteristics similar to analog characteristics of the first analog signal processing section; and
causing the emulation device to perform a process based on the signal supplied by the semiconductor device.

18. A method of emulating an operation of a target device including a first analog signal processing section, the method comprising:
causing an emulation device to generate a signal to be input to a second analog signal processing section of a semiconductor device and to supply the generated signal to an external terminal of the semiconductor device, the second analog signal processing section having analog characteristics similar to analog characteristics of the first analog signal processing section, and a signal from the outside being input to the second analog signal processing section through the external terminal; and
causing the second analog signal processing section to perform a process based on the supplied signal.
